(19) United States
(12) Patent Application Publication
(10) Pub. No.: US 2009/0295728 A1
(43) Pub. Date: Dec. 3, 2009

(54) Signal processing method for optical trace-detecting module

(75) Inventor: Yu-Quan Su, Taipei County (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei County (TW)

(21) Appl. No.: 12/230,146

(22) Filed: Aug. 25, 2008

(30) Foreign Application Priority Data
May 28, 2008 (TW) 097119775

(51) Int. Cl. G06F 3/033

(52) U.S. Cl. 345/166

(57) ABSTRACT

A signal processing method for an optical trace-detecting module is adapted to perform signal processing between a hardware device having an optical trace-detecting module and a computer device. After a hardware device performs signal connection with a computer device, a fingerprint recognition start-up is implemented by an optical trace-detecting module of the hardware device. Continuous image detection is then performed for displacement control. The presence of the hardware device is confirmed by a start-up procedure of the computer device. A single fingerprint image is picked up by the optical trace-detecting module of the hardware device so as to perform start-up ID recognition. After that, a plurality of frames of object images is continuously picked up by the optical trace-detecting module, and then converted into a displacement signal to be transmitted to the computer device, so as to control a window interface.

### CROSS-REFERENCE TO RELATED APPLICATIONS

This non-provisional application claims priority under 35 U.S.C. §119(a) on Patent Application No(s). 097119775 filed in Taiwan, R.O.C. on May 28, 2008, the entire contents of which are hereby incorporated by reference.

### BACKGROUND

1. Field of Invention

The present invention relates to a signal processing method, and more particularly to a method for processing an image picked up by an optical trace-detecting module.

2. Related Art

A pointing device generally refers to a hardware device capable of inputting coordinate displacement signals into a computer device (for example, a personal computer, notebook, or personal digital assistant). There are a variety of pointing devices, such as mice, trackball devices, touchpads, writing pads, and joysticks. Besides inputting coordinate displacement signals into a computer device according to movements of a user, a mouse is also provided with a scroll wheel for controlling a longitudinal scroll bar or lateral scroll bar of a window interface. Therefore, the mouse has become the currently most popular man-machine interface applicable to window systems.

After being the currently most popular man-machine interface for controlling the window systems, the mouse continuously evolves with the window systems. For example, US Patent Publication No. 20030179184 (referred to as Patent 184 below) and US Patent Publication No. 20040080492 (referred to as Patent 492 below) both disclose a fingerprint recognition mouse for controlling a security mechanism of a computer device. The fingerprint recognition mouse disclosed in Patent 184 is characterized in that a line sensor is disposed between two mouse buttons. Similarly, as for the fingerprint recognition mouse disclosed in Patent 492, an image trace-detecting device is disposed at the mouse. A fingerprint of a user can be obtained by the line sensor or the image trace-detecting device on the mouse and then subject to recognition, so as to control the start-up or file storage management of the computer device.

Further, U.S. Pat. Publication No. 7,298,362 (referred to as Patent 362 below) discloses a pointing device with finger-contact control. In Patent 362, a set of convex lenses and an optical signal processor are disposed on a mouse. An image can be picked up and then converted into a displacement signal by the set of convex lenses and the optical signal processor, so as to control a pointer of a window interface or replace a scroll wheel on a conventional mouse, thus controlling scroll bars of the window interface.

No matter for the fingerprint recognition mouse or the pointing device with finger-contact control, the line sensor or the optical signal processor disposed thereon is an optical sensor for picking up image information. Therefore, US Patent Publication No. 20050249386 (referred to as Patent 386 below) discloses a pointing device having fingerprint image recognition function. In Patent 386, fingerprint recognition and a displacement signal control are integrated. Fingerprint images are continuously and periodically acquired by a fingerprint acquiring means, then verified by a recognizing means, and converted into displacement data by a movement detecting means.

In Patent 386, the fingerprint images are continuously acquired to be verified by the recognizing means or converted by the movement detecting means. However, in most cases, the fingerprint recognition does not need not to be continuously performed. Moreover, since the fingerprint recognition involves security issues, requirements of the fingerprint recognition on the fingerprint images are stricter than those of the displacement information. In order to continuously and periodically use the fingerprint images as reference images for verification and conversion at the same time, the recognizing means must pick up and compare characteristic points of the fingerprint images, and the movement detecting means must pick up and calculate m*n pixels of the fingerprint images, referring to the method disclosed in Patent 386. Therefore, both the recognizing means and the movement detecting means perform calculations with the fingerprint images, and the continuous and periodic acquisition of fingerprint images fails to take operational purposes of the user into consideration. After all, the fingerprint recognition and displacement information are two different purposes, and need not to be simultaneously performed for the user. Although Patent 386 solves the hardware cost problem, computational complexity of the system is resulted.

### SUMMARY OF THE INVENTION

Although the conventional pointing device integrated with fingerprint recognition and displacement signal control solves the hardware cost problem, it neglects the fact that the fingerprint recognition and displacement information need not to be simultaneously performed in practical applications. Acquisition of fingerprint images followed by calculation thereof according to fingerprint recognition or displacement signal control results in computational complexity of the system. Accordingly, the present invention is directed to a signal processing method for an optical trace-detecting module integrated with fingerprint recognition and displacement signal control.

A signal processing method for an optical trace-detecting module includes the following steps.

A computer device performs an initialization start-up procedure so as to determine whether a hardware device having an optical trace-detecting module exists, and then performs a recognition procedure if the hardware device exists.

The optical trace-detecting module obtains and transmits a fingerprint image to the computer device.

It is determined whether the fingerprint image matches a default image of the computer device, and if yes, the computer device executes an operating system.

The optical trace-detecting module obtains a plurality of frames of finger images, i.e. continuous finger images, within a period of time, then converts the frames of the finger images into a displacement signal, and transmits the signal to the computer device.

In the signal processing method for an optical trace-detecting module of the present invention, only a single fingerprint image is recognized in the fingerprint recognition process. Moreover, the optical trace-detecting module picks up continuous displacement images and converts the images into a displacement signal after finishing the procedure of executing the operating system following the fingerprint recognition. Thereby, the image processing is greatly simplified and the system load is significantly alleviated.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an exemplary application of the present invention; and

FIG. 2 is a flow chart of the process of the present invention.

### DETAILED DESCRIPTION OF THE INVENTION

According to a signal processing method for an optical trace-detecting module of the present invention, the optical trace-detecting module is disposed on a hardware device and connected to a computer device via the hardware device, or directly disposed on a computer device. The hardware device may be an external computer peripheral device such as a mouse, a writing pad, and a trackball. The computer device may be a data processing device such as a desk-top computer, a notebook, and a personal digital processor. The following implementation is illustrated as the most preferred embodiment of the present invention, in which a mouse is used as the hardware device and a desk-top computer is used as the computer device.

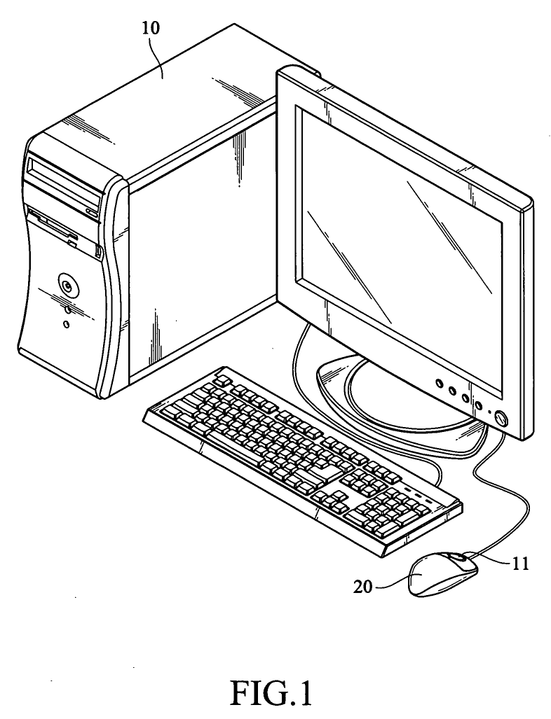

FIG. 1 shows a signal processing method for an optical trace-detecting module of the present invention. Referring to FIG. 1, a hardware device 10 is a mouse, and a computer device 20 is a desk-top computer. The mouse can perform signal connection with a desk-top computer in a wired or wireless manner. When the mouse moves on a plane, a displacement of the mouse on the plane is calculated in a mechanical or an optical manner, and is then converted into a displacement signal to be transmitted to the desk-top computer, so as to control the movement of a cursor of an operating system (for example, a Windows operating system) of the desk-top computer on a window interface.

The mouse is disposed with an optical trace-detecting module 11. The optical trace-detecting module 11 replaces a scroll wheel of a conventional mouse. Once a user contacts the optical trace-detecting module 11 with a finger or another object, the optical trace-detecting module 11 picks up an image of the finger or object, and the picked image of the finger or object, i.e. finger image, is processed using the signal processing method for an optical trace-detecting module of the present invention.

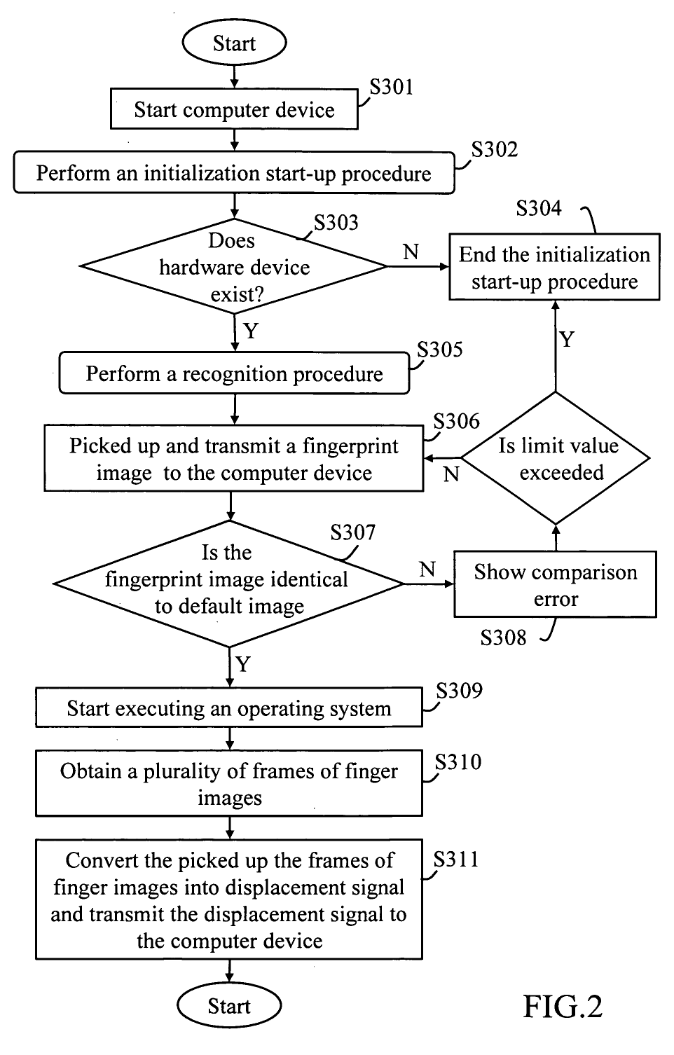

FIG. 2 is a flow chart of the signal processing of the present invention. Referring to FIG. 2, the computer device 20 is first started (Step S301). The computer device 20 performs an initialization start-up procedure (Step S302). The initialization start-up procedure detects whether primary hardware elements such as a central processing unit, a memory, and a storage device in the computer device 20 are in good order. The initialization start-up procedure also determines whether the hardware device 10 exists (Step S303). If the hardware device 10 does not exist, the computer device 20 ends the initialization start-up procedure (Step S304). If the hardware device 10 exists, the computer device 20 performs a recognition procedure (Step S305).

The recognition procedure first displays a prompt window on a display of the computer device 20. The prompt window says “Please Input a Fingerprint Image”. As long as the user places a finger on the optical trace-detecting module 11 of the hardware device 10, a fingerprint image is picked up by the optical trace-detecting module 11 and directly transmitted to the computer device 20 (Step S306).

After the computer device 20 receives the fingerprint image, the recognition procedure determines whether the fingerprint image is identical to a default image stored in the computer device 20 (Step S307). The default image pre-stored in the computer device 20 is a fingerprint image previously stored by the user. If the fingerprint image is not identical to the default image after comparison, the computer device 20 shows a comparison error (Step S308). Thus, a prompt window is displayed on the display, saying “Input Error, Please Rescan the Fingerprint”, and the user can again contact the optical trace-detecting module 11 of the hardware device 10 with a finger, such that the optical trace-detecting module 11 is able to pick up a fingerprint image again and directly transmit the fingerprint image to the computer device 20.

A limit value for the number of the comparison error is set in the recognition procedure. If the number of the comparison error exceeds the limit value, the computer device 20 ends the initialization start-up procedure (Step S304). If the fingerprint image is identical to the default image after comparison, the computer device 20 starts executing an operating system (Step S309). The operating system is, for example, a Windows operating system.

After entering the operating system, the user slides on the optical trace-detecting module 11 with a finger or another object. When the finger or another object slides along sensing surface of the optical trace-detecting module 11, the optical trace-detecting module 11 obtains a plurality of frames of finger images, i.e. continuous finger images within this period of time (Step S310). The hardware device 10 converts the picked up continuous finger images into a displacement signal and transmits the displacement signal to the computer device 20 (Step S311). The displacement signal may control scroll bars of a window interface in the computer device 20. In this embodiment, the hardware device 10 is a mouse, so the displacement signal converted by the optical trace-detecting module 11 controls the scroll bars of the window interface in the computer device 20. On the other hand, according to the signal processing method for an optical trace-detecting module of the present invention, if the computer device 20 is a notebook, the optical trace-detecting module 11 is directly disposed on the notebook. In this manner, a displacement signal converted by the optical trace-detecting module 11 is able to control the pointer of the window interface.

In practice, during the start-up fingerprint recognition, the optical trace-detecting module 11 only picks up one fingerprint image and directly transmits the image to the computer device 20. After entering the operating system following the start-up, the optical trace-detecting module 11 further picks up a plurality of continuous finger images from the finger or the other object sliding thereon within a period of time, then converts the continuous finger images into a displacement signal, and transmits the displacement signal to the computer device 20, so as to control the scroll bars of the window interface of the computer device 20. In other words, whether the computer device starts to perform the operating system or not is determined according to the fingerprint image is picked up by the optical trace-detecting module. Furthermore, after the computer device start, the optical trace-detecting module detects the shift of the finger to obtain continuous finger images, such as to generate the displacement signal to control operation of the computer device, such as move the cursor. Therefore, the integration of fingerprint recognition and displacement signal control is achieved, the image processing is greatly simplified, and the system load is significantly alleviated.

What is claimed is:

1. A signal processing method for an optical trace-detecting module, adapted to perform signal processing between a hardware device having an optical trace-detecting module and a computer device, the method comprising:
starting the computer device;
performing an initialization start-up procedure and detecting the hardware device;
performing a recognition procedure when the hardware device exists;
picking up and transmitting a fingerprint image to the computer device by the optical trace-detecting module;
comparing the fingerprint image transmitted from the optical trace-detecting module and a default image stored in the computer device in the recognition procedure;
executing an operating system when the fingerprint image is identical to the default image;
obtaining a plurality of frames of finger images by the optical trace-detecting module within a period of time when executing the operating system; and
converting the plurality of frames of finger images into a displacement signal and transmitting the displacement signal to the computer device.

2. The signal processing method for an optical trace-detecting module according to claim 1, further comprising:
ending the initialization start-up procedure when the hardware device does not exist.

3. The signal processing method for an optical trace-detecting module according to claim 1, further comprising:
displaying a comparison error when the fingerprint image is not identical to the default image.

4. The signal processing method for an optical trace-detecting module according to claim 3, wherein a limit value for the number of the comparison error is set in the recognition procedure, and further comprising: ending the initialization start-up procedure of the computer device when the number of the comparison error exceeds the limit value.
